(19) United States
(12) Patent Application Publication
(10) Pub. No.: US 2005/0225599 A1
(43) Pub. Date: Oct. 13, 2005

(54) Inkjet maintenance kit

(76) Inventors: Alan L. Hudd, Nuthampstead (GB); Philip G. Bentley, Cambridge (GB); Alistair J. Scott, Impington (GB)

Correspondence Address: 3M INNOVATIVE PROPERTIES COMPANY, PO BOX 33427, ST. PAUL, MN, 55133-3427, US

(21) Appl. No.: 10/520,977

(22) PCT Filed: May 16, 2002
(86) PCT No.: PCT/US02/15774

§ 371 Date: Jan. 11, 2005

(30) Foreign Application Priority Data
May 30, 2001 (GB) 0113094.7

(51) Int. Cl. B41J 2/04

(52) U.S. Cl. 347/54

(57) ABSTRACT

An automatic maintenance unit for a static print head used in a drop on demand inkjet printer is provided by a combination of a removable capping element to abut and cover ink ejection nozzles and a movable wiping element including a wiper to remove residual ink after removal of the capping element and before commencement of a print run, thereby avoiding the need for manual capping and decapping and cleaning of the print head and speeding up the printing cycle. The capping clement is preferably mounted pivotally so that it can be swung between a capping position between print runs and a retracted position during print runs, and the wiper is preferably mounted on a frame to move outwards and upwards from a retracted position adopted during print runs, to a position above the nozzles and then downwards across the nozzles to clean them prior to a print run before returning to the retracted position.

### FIELD OF THE INVENTION

This invention relates to inkjet printing, in particular to the maintenance of a multichannel print head unit.

### BACKGROUND OF THE INVENTION

A wide range of inkjet printers is available commercially, from single-user desktop units through more rugged multiple-user office units to industrial systems. Operationally they are of two different types: continuous inkjet (CU) and drop on demand (DOD). The present invention is particularly concerned with industrial units of the latter type, in which ink from a reservoir passes through a feed channel to a static print head having a face plate with an array of ejection nozzles each fed though fine capillary channels, typically of 30-40 μm internal diameter. Ink droplets to form a desired image on a substrate are ejected from the nozzles by controlled energy pulses induced by piezoelectric or thermal elements associated with the respective capillaries.

At the start of a typical printing operation ink is fed from the reservoir to the print head both to prime the capillaries and to purge from the nozzles any air bubbles or solid or viscous residues of previous operations. When printing commences a flow of ink is maintained to the capillaries to replace the ink ejected as droplets. The ink is delivered to the capillaries at a relatively low pressure so as to maintain a slight negative pressure at the nozzles, typically 1 to 2 in. water gauge (0.25 to 0.5 kPa), and thereby avoid emission of ink from the nozzles other than under the action of the controlled energy pulses.

In most industrial applications regular manual maintenance of the print head is effected before and after a print run. The maintenance may include a “prime and wipe” before beginning the run and manual capping of the print head after the run. The priming and wiping entails a small amount of ink being gently forced out of the print head nozzles followed by gently wiping the ink off the face plate with a cleaning element, for example a rubber blade or a lint-free soft cloth. Capping is typically accomplished by placing a pad or cap over the nozzles and holding it firmly in place against them. The effect of priming, wiping, and capping is to prepare the print head for a print run, ensuring no potentially harmful ink residues on the face plate and maintaining the ink in the capillaries in good condition by inhibiting the loss of solvent.

Substrate materials to which the ink droplets are applied include ceramics or glass; metals such as aluminium, stainless steel and tin plate; paper, from cardboard and plain copier grades to high quality coated grades; and plastics such as polyacetals, polyesters, polyethylenes and polystyrenes. The substrate may be simply in sheet form, or be shaped as in bottles, cans or other containers.

A similarly wide range of images can be applied to the substrate according to the required duties and the complexity of the print head. Possible images include lettering, numerals, figures, photographs, pictures, logos, identifying marks, “sell-by” or “use by” dates, batch numbers, address details and general text. The required degree of precision of the image depends on the duty but the demand in almost every case is for a high speed of application and thus a high frequency of droplet ejection.

The large number of possible combinations of printer type, substrate and required image has led to a wide variety of ink types being developed for specific duties. The ink is basically a marker dispersed in a solvent medium but various additives may also be needed, for example dispersants, conductivity controllers or adhesion promoters. In general the marker may be selected from one or more dyes or solid particulate materials, in solution or suspension in the solvent. The markers may be of a type that imparts to the deposited image a coloration which is visible in daylight or conventional artificial lighting, or may have no marked colour in daylight or conventional artificial lighting but reveal their colour under special lighting, for example from an ultra-violet or LED source. Alternatively the markers may be pigments or additives which reveal their presence under the application of magnetic, electronic or spectroscopic means. For example a pigment or an additive with magnetic properties provides a magnetically detectable image.

Examples of types of pigments used in inkjet printer inks are metallic flakes, inorganic materials comprising ferrites and other metal oxides, including oxides of transition and rare earth metals; organo-metallic complexes; and organic materials, including high molecular weight aromatic compounds such as anthraquinones, aryl amides and quinacridones. Specific examples of commonly used pigments include magnetite, barium ferrite, strontium ferrite, iron oxide, titanium dioxide, copper phthalocyanine and carbon black.

Two important properties of the ink are its viscosity and surface tension. The viscosity should be relatively low, typically in the range 2 to 20 cP (0.002 to 0.02 Pas) at the operating temperature of the print head, such that even when loaded with pigment and additives the ink can pass freely through the flow channels in the print head. In some instances it may be appropriate to reduce the viscosity by increasing the operating temperature of the print head.

The surface tension of the ink should be selected so that a stable meniscus exists across the nozzle openings when droplets are not being ejected. A typical range of surface tension to meet this objective is 29-38 dyn/cm (mN/m).

Examples of classes of solvents used in inkjet printer inks include acetates, alcohols, aldehydes, esters, ethers, glycols, glycol ethers, hydrocarbons, ketones and lactates. Commonly used solvents include acetone, diacetone alcohol, ethanol, ethyl acetate, ethyl lactate, ethylene glycol, diethylene glycol, butyl acetate, butyl lactate, benzyl alcohol, methyl ethyl ketone, propylene, propylene glycol, methoxy propanol, methoxy propyl acetate and water.

Escape of ink from the print head nozzles poses several potential problems. Residual ink on the face of the print head after a print run leads to undesired deposits on the face, may cause undesired or uneven deposition of ink on the substrate, or may lead to blockage of the nozzles as solvent evaporates and leaves high solid concentrations in the ink. Certain of the ink components may be expensive and therefore used sparingly for reasons of economy. All of the inks are likely to cause unacceptable staining of articles to which they inadvertently come into contact. It is therefore desirable to use only as much ink as is strictly necessary for a given print run and to dispose effectively of any ink that is necessarily ejected for reasons other than printing.

Many previous proposals have been made for maintenance stations for inkjet print heads, although these have mostly been for use with moving print heads rather than static heads and they have tended to be relatively complex systems, with attendant problems of reliability.

European patent application EP 1016528 discloses an ink jet printer with a wiper blade cleaning mechanism for use on a print head surface. The wiper blade has a complex structure incorporating a first passageway for conveying liquid solvent to the surface. The solvent flushes contaminants from the surface and entrains them. The wiper blade also includes a plurality of wicking channels which can be aligned with the surface and a second passageway in communication with these channels. A vacuum pump in communication with the second passageway draws solvent and entrained contaminants from the surface, along the wicking channels and through the second passageway. Additionally a piping circuit filters particulate matter from the solvent and recirculates filtered solvent into the first passageway and thus onto the surface of the print head.

International patent application WO 98/45122 discloses an inkjet printer with a service station comprising a wiper device capable of cleaning the face of a print head. The main purpose for the wiper device is however to apply to the face a viscous sealing liquid so as to seal the nozzles and prevent the ink in the print head from drying. The service station stores the sealing liquid and has an applicator mechanism including a dispenser member from which sealing liquid is transferred by means of the wiper to the print head.

U.S. Pat. No. 6,145,958 relates to a system for cleaning an inkjet print head by using a wiper that moves between a wiping position for cleaning ink residue from the print head, a scraping position for scraping residue from the wiper, and a solvent application position. A porous body portion impregnated with solvent moves the solvent under capillary action from a scraper portion towards an applicator and filters dissolved ink residue from the ink solvent The applicator applies ink solvent to the wiper and the scraper scrapes ink residue from the wiper.

The present invention seeks to provide a simple automated maintenance station for wiping and capping the print head of a drop on demand inkjet printer, especially for industrial applications of the printer.

### SUMMARY OF THE INVENTION

According to the present invention there is provided a print head unit for a drop on demand inkjet printer, including a face plate with an array of capillary channels each with an ejection nozzle and a controlled pulsing element, in which the print head supports an automated maintenance device which comprises a removable capping element to abut the face plate so as to cover the ejection nozzles and supports a movable wiping element including a wiper to remove ink from the face plate after removal of the capping element and before commencement of a print run.

The automated maintenance device of the invention is primarily intended, and is most suitably employed, for a printer with a static print head. The combination of an automated capping element and wiping element supported on the print head not only avoids the need for manual capping and decapping and cleaning of the print head but also considerably speeds up the printing cycle. Maintenance units according to one embodiment of the invention can complete the cap removal and wiping phase in a total of less than 25 seconds.

Between print runs the capping element remains in position against the face plate. This prevents escape of ink from the nozzles and keeps the ink in a stable condition by preventing evaporation of the solvent and preventing access by minute dust particles.

A priming pump supplies ink to the print head, capillaries and nozzles as a preliminary step before the start of a print run. A long priming action is typically only required during the initial set-up of the print head. The capping element is removed from the face plate and a pulse of ink is ejected through the nozzles to clear any air bubbles or residues. The wiping element is then brought into action to clean any ink from the face plate and is then moved away from the face plate. Printing thus commences and continues from a clean face plate, with clean and thus enhanced operation of each of the individual nozzles and avoiding deposition of unwanted ink residues on the substrate. At the end of the print run the capping element is returned to the face plate.

The priming and wiping action is preferably performed each time the print head is uncapped or if the print head has been left uncapped for longer than the ink's specified “decap” (decapped) time.

The capping element is preferably spring-mounted. This helps to provide a sufficient and even pressure against the face plate to create a film seal. The portion of the capping element that comes into contact with the face plate is preferably formed of an elastomeric material, for example natural rubber, nitrile rubber and resilient plastic, although in each case they should be of a type that is resistant to the particular solvent employed in the ink. By way of example, the said portion may be formed of a contact pad which abuts against the face plate across all of the nozzle openings or alternatively it may be a cap incorporating a continuous ridge around the portion of the face plate in which the nozzle openings are located. In the latter case there is no direct contact between the capping element and the nozzle openings, the cap forming a sealed hollow space against the nozzle openings. The former option gives a direct seal against each individual nozzle but the pad may become marked with ink from the nozzles. The latter option has less risk of contamination by the ink but must be carefully constructed to ensure a good seal around the whole periphery of the nozzle area.

The capping element is preferably mounted pivotally to the print head so that it can be swung into position against the face plate in the capping phase and swung away from the face plate into a retracted position for the printing phase. Its movement is effected by a suitable motor, the drive from the motor being preferably a worm gear (a worm and a worm wheel) which can impose a high level of pressure against the face plate. Such a worm gear also ensures that once the contact pad is in the desired position the worm firmly holds it in that position.

The wiper may be an absorbent pad or a blade and may conveniently be mounted on a supporting frame. It preferably comprises a resilient blade of elastomeric material which, as with the capping element, should be of a type that is resistant to the particular solvent employed in the ink. The wiping action is preferably effected in a downwards direction so as to facilitate the ink removal. A great advantage of a resilient blade is that it provides for a “flick” action whereby residual ink is flicked away from the face plate and not absorbed or otherwise permitted to remain in the vicinity of the wiper.

Preferably an absorbent pad is provided on or close to the print head to receive the ink removed by the wiper and thereby prevent the ink from doing any harm to the printing or the print operators. The pad is preferably located just beneath the face plate so as to receive ink falling from or flicked from the face plate. It should be located so that while not interfering with the free travel of the wiper it is contacted by the wiper so as to remove therefrom any ink remaining on it.

The preferred path of travel of the wiper is to move from a retracted position beneath the face plate, upwards past the face plate without contacting it, moving into contact with the face plate above the nozzles, moving downwards across the nozzles while remaining in contact with the face plate and then contacting an absorbent pad before returning to the retracted position.

### BRIEF DESCRIPTION OF THE DRAWINGS

FIG. 1 is a side view of an inkjet print head fitted with a maintenance unit according to the invention comprising a wiping element and capping element. The unit is shown with these elements away from the print head.

FIG. 2 is a side view of the print head and unit of FIG. 1, with its wiping element in wiping action.

FIG. 3 is a side view of the print head and unit of FIGS. 1 and 2, with its capping element in its capping position.

FIG. 4 is a front view of the print head and unit of FIGS. 1 to 3, as seen from V in FIG. 1, i.e. with its wiping and capping elements in their retracted positions.

### PREFERRED EMBODIMENTS OF THE INVENTION

In one convenient embodiment of the invention the wiping element frame comprises a triple-lever structure including a support lever pivotally mounted on the print head, a drive lever pivotally and eccentrically mounted on a drive wheel, and a carrier lever pivotally mounted at one end on the support lever and holding the wiper at the other end. Preferably the frame includes two such triple-lever structures, one on either side of the print head and linked to each other across the print head by tie bars. In a particularly convenient arrangement the wiper is disposed on a tie bar which joins the ends of the two carrier levers away from the support levers. The triple lever structure provides for the wiper to follow the preferred path, as the drive wheel is rotated, from beneath the face plate, upwards but remote from the face plate, and downwards in a substantially straight line against the face plate.

The maintenance unit preferably includes separate drive motors for the capping and wiping functions. The range of movement of the respective elements is preferably controlled by limit switches. The drive motors and associated switches are preferably controlled by logic circuitry. An advantage of such circuitry is that it can prevent the wiping element from being operated if the face plate is capped and, vice versa, the capping element cannot be operated if the wiping action is in progress. There is no special requirement for the drive motors, associated switches or the logic circuitry, all of which can be commercially available units. The motors can be chosen from any conventional electric motor of a suitable size and power output.

In one convenient embodiment of the invention, operation of the capping and wiping functions is accomplished via three control push switches:
Switch 1 caps and uncaps the print head
Switch 2 operates the priming pump for a long prime; mainly used for initial set-up of the print head.
Switch 3 briefly operates the priming pump so as to create a small and gentle bleed of ink out of the nozzles and then operates the wiping element to remove any ink remaining on the face plate.

The invention thus provides a printing system which is maintained in a position from which it can quickly and easily be brought into operation. It further ensures that usage of ink beyond the volumes needed for the printing is kept to a minimum, representing a saving in raw material costs and a reduction in the possibility of ink escaping to cause unintentional marks or otherwise create undesirable effects.

The invention further provides a printer incorporating a print head as defined above.

For purposes of control or monitoring of printing operations the printers according to the invention can be employed in association with one or more microprocessors, for example a programmable logic controller. Each microprocessor can be located alongside the printer or remote from it. In one convenient arrangement one microprocessor forms part of the apparatus as such and another microprocessor is located remotely. A remote location is beneficial in permitting a reduction in on-site inspection time by local personnel and in permitting several application stations to be monitored and controlled from a single point. The microprocessors can be configured to receive data electronically by such transmission routes as a direct wiring connection, dedicated telephone line, radio link or internet link.

The present invention is further described with reference to a version of inkjet maintenance unit according to the invention and illustrated in the accompanying figures. It is emphasised that the invention is not limited to this specific version and that not all of the components illustrated in this version represent essential features of the invention.

The print head unit comprises a print head body portion 10, of a type marketed as a Trident Ultrajet”, which has a face plate 12, multiple nozzles 14 and internal ink channels and capillaries (not shown). Each of the capillaries has an associated piezoelectric element (not shown) operable by controlled energy pulses to convey ink to the nozzles 14. A pad 15 of absorbent fabric extends across the body portion 10 beneath the face plate 12. A shaped capping arm 16 is disposed on a shaft 18 mounted on the upper side of the body portion 10. A capping plate 20 with a facing pad 22 of solventresistant nitrile rubber is mounted on a spring-loaded rod 24 which passes through the arm 16. The spring-loaded rod 24 is held loosely in the vertical and lateral directions to permit a degree of self adjustment of the capping plate 20 on being aligned with the face plate 12.

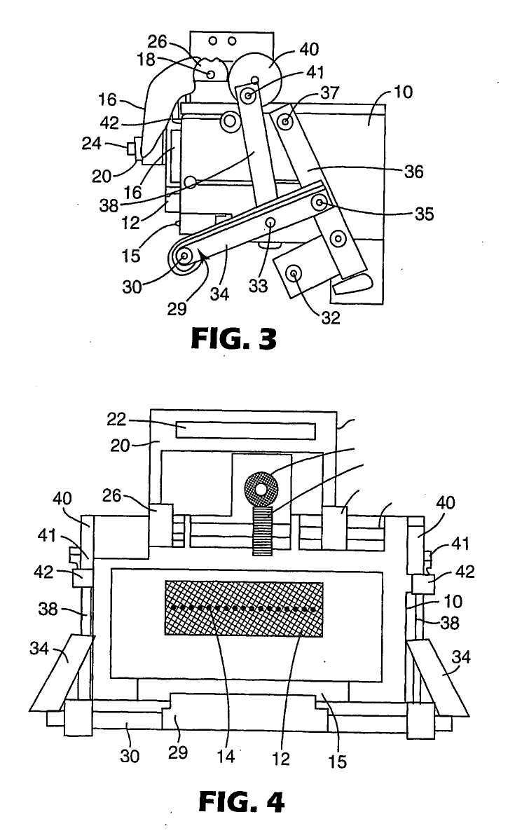

The capping arm 16 with its associated plate 20 and facing pad 22 form a capping element that is rotatable about the shaft 18. A worm gear comprising a worm wheel 17 on the shaft 18 that is driven by a worm 19 powered by an electric motor (not shown) moves the capping element between the “parked” retracted position shown in FIGS. 1 and 4 and a capping position as shown in FIG. 3. Use of a worm drive provides a significant force to hold the facing pad 22 firmly in the capping position against the face plate 12. The extent of travel of the capping arm 16 is governed by two micro switches (not shown), one at each end of its travel, which are operated by cams 26 mounted on the shaft 18.

A wiper blade 29 is located on a tie bar 30 which extends across the width of the body portion 10. The tie bar 30 forms part of a lever frame comprising levers 34, 36 and 38 movable by a wheel 40 driven by an electric motor (not shown). One set of levers 34, 36 and 38 is visible at the near side of the body portion 10 as viewed in FIGS. 1 to 3. An equivalent set is located at the other side of the body portion 10 as shown in FIG. 4. The tie bar 30 and a further connecting tie bar 32 link levers 34 and 36 on the near side to their corresponding levers 34 and 36 on the other side so as to give stability to the lever frame.

The lever 36 is pivotally mounted on the body portion 10 at a fixed pivot point 37. The lever 34 is pivotally mounted on the lever 36 at a pivot point 35 and in turn carries a pivot point 33 on which the lever 38 is pivotally mounted. The upper end of lever 38 is eccentrically mounted on the driving wheel 40 at point 41 such that it is raised and lowered by rotation of the driving wheel 40. Movement of the lever 38 is further controlled by a fixed guide stud 42 on the body portion 10.

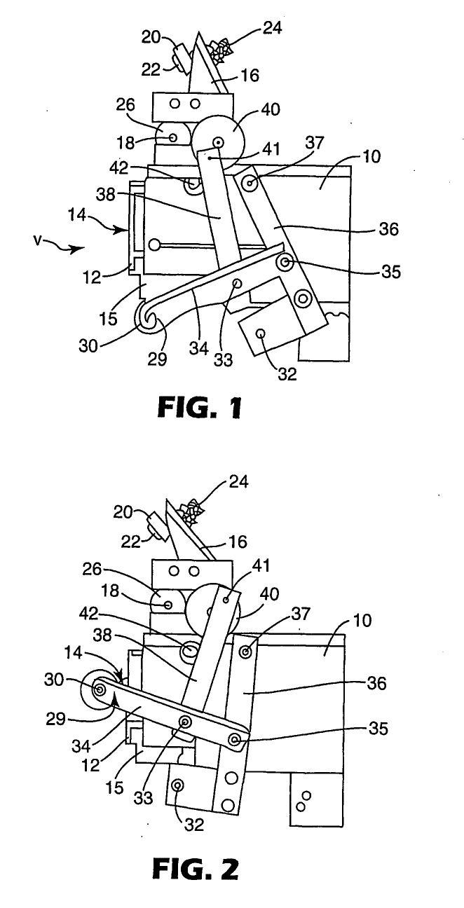

Operation of the blade lever frame first moves the blade 29 from its parked position under the face plate 12 as shown in FIGS. 1, 3 and 4 through a path in which it swings outwards and upwards past the print head body portion 10 and then into contact with it above the nozzles 14 as shown in FIG. 2. The blade 29 then passes from the upper position above the nozzles 14 and moves vertically downwards in contact with the print head body portion 10 past the nozzles 14 to wipe the face plate clean. Before returning to its parked position the blade 29 contacts the absorbent pad 15 which removes any ink from the blade 29. As with the capping arm 16, the upper and lower limits of travel of the blade 29 are governed by two cam-operated micro switches (not shown).

In the illustrated unit, control logic prevents the wiping element from being operated if the face plate 12 is capped and, vice versa, the capping element being operated if the wiping action is in progress.

Prior to a print run the print head is at rest as shown in FIG. 3 with the capping arm 16 holding the facing pad 22 firmly against the face plate 12. The capping arm 16 is moved away to the position shown in FIGS. 1 and 4 and the lever frame is then activated to move the wiper blade 29 from its parked position to its upper position, slightly above the nozzles 14. The print head body portion 10 is then primed with ink and the nozzles 14 purged by the action of a priming pump (not shown) remove any air bubbles or residual matter.

The blade 29 is then moved against the face plate 12. Continued rotation of the drive wheel 40 causes the frame to draw the blade 29 vertically downwards from the position shown in FIG. 2 and over the nozzles 14 to remove any ink from the face plate 12. Most of any ink on the face plate is flicked away by the wiping action of the blade 29 and is deposited on the absorbent pad 15 either directly or by contact between the pad 15 and the blade 29.

The print head is now ready for a print run, with the capping arm 16 and blade lever frame held away from the print head as shown in FIG. 1, thereby being well out of the projection path of the ink to the substrate to be printed and thus ensuring no interference to the print operation from the capping and wiping mechanisms. At the end of the run the capping arm 16 is returned to the capping position of FIG. 3.

The volume of ink removed from the face plate 12 is readily taken up by the absorbent pads (15) and is thus effectively removed from the system and held within the pad 15 such that they cannot serve any harmful purpose. The pad 15 is replaced with a fresh pad at the end of a series of print runs.

1. A print head unit for a drop on demand inkjet printer, including a face plate with an array of capillary channels each with an ejection nozzle and a controlled pulsing element, in which the print head body portion supports an automated maintenance device which comprises a shaped capping arm to abut the face plate so as to cover the ejection nozzles and supports a movable wiping element including a wiper blade to remove ink from the face plate after removal of the capping element and before commencement of a print run.

2. A print head unit as claimed in claim 1, in which the capping element is spring-mounted.

3. A print head unit as claimed in claim 1, in which the facing pad of the capping element that comes into contact with the face plate is formed of an elastomeric material which is resistant to the solvent employed in the ink.

4. A print head unit as claimed in claim 3, in which the portion of the capping element that comes into contact with the face plate is in the form of a facing pad which abuts against the face plate across all of the nozzles.

5. A print head unit as claimed in claim 3, in which the facing pad of the capping element that comes into contact with the face plate is in the form of a cap incorporating a continuous ridge around the portion of the face plate in which the nozzles are located.

6. A print head unit as claimed in claim 1, in which the capping element is mounted pivotally to the print head so that it can be swung into position against the face plate in the capping phase and swung away from the face plate into a retracted position for the printing phase.

7. A print head unit as claimed in claim 1, in which the capping element is motor-driven via a worm and worm wheel.

8. A print head unit as claimed in claim 1, in which the wiping action is effected in a downwards direction.

9. A print head unit as claimed in claim 1, in which the wiper blade comprises a resilient blade of elastomeric material which is resistant to the solvent.

10. A print head unit as claimed in claim 1, in which one or more absorbent pads are provided on or close to the print head to receive ink removed by the wiper blade.

11. A print head unit as claimed in claim 1, in which the path of travel of the wiper blade is to move from a retracted position beneath the face plate, upwards past the face plate without contacting it, moving into contact with the face plate above the nozzles, moving downwards across the nozzles while remaining in contact with the face plate and then contacting an absorbent pad before returning to the retracted position.

12. A print head unit as claimed in claim 1, in which the wiping element includes a frame to support the wiper blade.

13. A print head unit as claimed in claim 12, in which the frame comprises a triple-lever structure including a support lever pivotally mounted on the print head, a drive lever pivotally and eccentrically mounted on a drive wheel, and a carrier lever pivotally mounted at one end on the support lever and holding the wiper blade at the other end.

14. A print head unit as claimed in claim 13, in which the frame includes two such triple-lever structures, one either side of the print head and linked to each other across the print head by tie bars.

15. A print head unit as claimed in claim 14, in which the wiper blade is disposed on a tie bar which joins the ends of carrier levers.

16. A print head unit as claimed in claim 1, which includes separate drive motors for the capping and wiping functions.

17. A print head unit as claimed in claim 1, in which the range of movement of the respective elements is controlled by limit switches.

18. A print head unit as claimed in claim 16 in which the drive motors and associated switches are controlled by logic circuitry.

19. A printer incorporating a print head unit of claim 1.

20. A printer as claimed in claim 19, in combination with one or more microprocessors for control or monitoring purposes.
